(19) United States
(12) Patent Application Publication
(10) Pub. No.: US 2022/0401763 A1
(43) Pub. Date: Dec. 22, 2022

(54) DUAL GASKET FOR USE WITH FACE MASKS

(71) Applicant: Christopher J. Leger, Mount Holly, NJ (US)

(72) Inventor: Christopher J. Leger, Mount Holly, NJ (US)

(21) Appl. No.: 17/352,735

(22) Filed: Jun. 21, 2021

(51) Int. Cl. A62B 18/08; A62B 9/04; A62B 18/04

(52) U.S. Cl. CPC A62B 18/084; A62B 9/04; A62B 18/04; A62B 18/082

(57) ABSTRACT

A gasket apparatus for use with a self-contained breathing apparatus, comprising an inner gasket portion adapted to form an airtight seal with a substrate such as a human head or face, wherein the inner gasket portion includes at least one type of connector device formed thereon or attached thereto; an outer gasket portion formed partially or completely around the inner gasket portion, wherein the outer gasket portion is adapted to receive at least one type of connecting device thereon for connecting one or more items to the outer gasket portion without disrupting the airtight seal formed by the inner gasket portion; and an interstitial space formed between the inner gasket portion and the outer gasket portion.

### BACKGROUND

The disclosed inventive subject matter relates in general to a protective equipment used in hazardous environments, and more specifically to a modified face piece or face mask gasket for use with breathing systems and devices used in firefighting and for other purposes.

A self-contained breathing apparatus (SCBA), also referred to as a compressed air breathing apparatus (CABA) or simply breathing apparatus (BA), is a wearable system and/or device that provides breathable air in atmospheres or environments that are immediately dangerous to human life or human health. The term “self-contained” indicates that an SCBA is not dependent on a remote supply of breathing gas (e.g., through a length of hose). If designed for use under water, such systems are referred to as self-contained underwater breathing apparatuses (SCUBA). When not used underwater, these systems are sometimes referred to as industrial breathing sets, air packs, air tanks or simply packs, which are primarily used for firefighting. An SCBA typically includes three primary components: (i) a high-pressure gas tank; (ii) a pressure regulator, and (iii) an inhalation device (e.g., mouth mask, face mask, or face piece), connected to one another and mounted on a carrying frame. A flame-resistant hood or similar device may be attached to the face mask to provide further protection to the wearer of the SCBA. Such systems are typically used for firefighting and industrial applications, although medical applications have recently become relevant. For example, the American National Institutes of Health prescribe the use of SCBAs for medical staff during treatment of Ebola and other dangerous pathogens.

An SCBA is typically an open-circuit system or in the case of a SCUBA, either an open-circuit system or closed-circuit system. A closed-circuit system, also known as a rebreather, operates by filtering, supplementing, and recirculating exhaled gas and is used when a longer-duration supply of breathing gas is needed, such as in mine rescue or operation in passages that are too narrow to accommodate the large gas cylinders used with open-circuit systems. Open-circuit industrial breathing sets are filled with filtered, compressed air, rather than pure oxygen. Typical open-circuit systems have two regulators: (i) a first stage regulator for reducing the pressure of air to allow it to be carried to the face mask, and (ii) a second stage regulator to further reduce air pressure to a level just above standard atmospheric pressure. This air is then fed to the face mask by a demand valve (activating only on inhalation) or a continuous positive pressure valve (providing constant airflow to the mask). An open-circuit rescue or firefighter SCBA typically includes a full-face mask, regulator, air cylinder, cylinder pressure gauge, remote pressure gauge, and a harness with adjustable shoulder straps and waist belt which allows the system to be worn on the back.

Open circuit SCBAs operate using either positive pressure or negative pressure. A negative pressure system relies on the internal pressure of the face mask dropping to below the ambient pressure to activate gas flow. If the mask does not seal properly, some leakage of ambient air into the mask will occur, which can be very problematic in environments containing toxic gases or irritant smoke and fumes. A positive pressure system slightly pressurizes the interior of the face mask and activates gas flow when the internal pressure is reduced, but is still above ambient pressure. If the face mask leaks, continuous gas flow maintains the internal pressure, and no inward leakage will occur. When the face mask fits correctly and seals properly around the face of the wearer, this design is economical with regard to the amount of breathing gas used and prevents contamination from the outside environment. Although the performance of both types of SCBA systems may be similar under optimum conditions, this “fail safe” aspect of a positive pressure SCBA makes it preferable for most applications.

As indicated above, the quality of the seal formed by the face mask in an SCBA is an important aspect of system performance. In most SCBAs used for firefighting, the seal at the edge of the face mask includes a wide tube-like structure having thin, flexible walls around the periphery of the face mask, filled with air at atmospheric pressure. On the surface, the seal pushes against the edges of the wearer's face, creating a tight seal despite small variations in head shape. Maintaining the integrity of this seal is critical with regard to proper functioning of the face mask and entire SCBA system. However, because the sealing portion of many face masks include snaps, tabs, buckles, and other connectors for attaching protective hoods or other items to the face mask, the seal can be reduced or even broken when the face mask is in use, thereby potentially creating serious problems for the wearer. Accordingly, there is an ongoing need for a face mask for use with SCBA systems that includes a means for attaching items to or near the sealing portion of the face mask without negatively affecting the quality of the seal formed between the face mask and face of the wearer of the SCBA system.

### SUMMARY

The following provides a summary of certain example implementations of the disclosed inventive subject matter. This summary is not an extensive overview and is not intended to identify key or critical aspects or elements of the disclosed inventive subject matter or to delineate its scope. However, it is to be understood that the use of indefinite articles in the language used to describe and claim the disclosed inventive subject matter is not intended in any way to limit the described inventive subject matter. Rather the use of “a” or “an” should be interpreted to mean “at least one” or “one or more”.

One implementation provides a gasket apparatus, comprising an inner gasket portion, wherein the inner gasket portion is adapted to form an airtight seal with a substrate, and wherein the substrate is a human face; an outer gasket portion formed partially or completely around the inner gasket portion, wherein the outer gasket portion is adapted to receive at least one type of connecting device thereon for connecting one or more items to the outer gasket portion without disrupting the airtight seal formed by the inner gasket portion; and an interstitial space formed between the inner gasket portion and the outer gasket portion.

The gasket apparatus may be adapted for use with a self-contained breathing apparatus, which may be adapted for use in industrial environments, commercial environments, household environments, firefighting environments, biohazard environments, medical environments, or military environments. The outer gasket portion and inner gasket portion may be formed integrally with one another from a single piece of material. The inner gasket portion may include at least one type of connector device formed thereon or attached thereto. The at least one type of connector apparatus on the inner gasket portion may be adapted to receive a head harness. The at least one type of connecting device on the outer gasket portion may include snaps, buttons, buckles, rivets, or hooks and loop connectors. The at least one type of connecting device on the outer gasket portion may be adapted to receive a protective item such as a hood, a helmet, a head covering, or the like. The interstitial space formed between the inner gasket portion and the outer gasket portion may be adapted to receive a portion of a protective hood therein.

Another implementation provides a dual gasket apparatus for use with a self-contained breathing system or apparatus, comprising an inner gasket portion, wherein the inner gasket portion is adapted to form an airtight seal with a substrate such as a head or face, and wherein the inner gasket portion includes at least one type of connector device formed thereon or attached thereto; an outer gasket portion formed partially or completely around the inner gasket portion, wherein the outer gasket portion is adapted to receive at least one type of connecting device thereon for connecting one or more items to the outer gasket portion without disrupting the airtight seal formed by the inner gasket portion; and an interstitial space formed between the inner gasket portion and the outer gasket portion, wherein the outer gasket portion and inner gasket portion are formed integrally with one another from a single piece of material.

The dual gasket apparatus may adapted for use with a self-contained breathing apparatus that is adapted for use in industrial environments, commercial environments, household environments, firefighting environments, biohazard environments, medical environments, or military environments. The at least one type of connector apparatus on the inner gasket portion may be adapted to receive a head harness. The at least one type of connector apparatus on the inner gasket portion may be a gasket tab. The at least one type of connecting device on the outer gasket portion may include snaps, buttons, buckles, rivets, or hooks and loop connectors. The at least one type of connecting device on the outer gasket portion may be adapted to receive a protective item such as a hood, a helmet, a head covering, or the like. The interstitial space formed between the inner gasket portion and the outer gasket portion may be adapted to receive a portion of a protective hood therein.

Still another implementation provides a gasket apparatus for use with a self-contained breathing apparatus, comprising an inner gasket portion, wherein the inner gasket portion is adapted to form an airtight seal with a substrate such as a human face, and wherein the inner gasket portion includes at least one type of connector device formed thereon or attached thereto; an outer gasket portion formed partially or completely around the inner gasket portion, wherein the outer gasket portion is adapted to receive at least one type of connecting device thereon for connecting one or more items to the outer gasket portion without disrupting the airtight seal formed by the inner gasket portion; and an interstitial space formed between the inner gasket portion and the outer gasket portion, wherein the outer gasket portion and inner gasket portion are formed integrally with one another from a single piece of material, and wherein the inner and outer gasket portions are adapted to mount to a visor used with a self-contained breathing apparatus.

The at least one type of connector apparatus on the inner gasket portion may be a gasket tab for receiving a head harness, and the at least one type of connecting device on the outer gasket portion may include snaps, buttons, buckles, rivets, or hooks and loop connectors. The at least one type of connecting device on the outer gasket portion may be adapted to receive a protective hood, and the interstitial space formed between the inner gasket portion and the outer gasket portion may be adapted to receive a front portion of the hood therein.

It should be appreciated that all combinations of the foregoing concepts and additional concepts discussed in greater detail below (provided such concepts are not mutually inconsistent) are contemplated as being part of the inventive subject matter disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed inventive subject matter and, together with the general description given above and detailed description given below, serve to explain the principles of the disclosed subject matter, and wherein:

FIG. 1A is a front view of a first prior art face piece (e.g., Scott V-2000) compatible with the disclosed apparatus;

FIG. 1B is an exploded view of the face piece of FIG. 1;

FIG. 2A is a front view of a second prior art face piece (e.g., Scott V-3000) compatible with the disclosed apparatus;

FIG. 2B is an exploded view of the face piece of FIG. 2A; and

FIG. 3 is a side view of an example implementation of the disclosed face piece showing the relative positions of the inner and outer portions of the dual gasket assembly.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed inventive subject matter. Accordingly, the following implementations are set forth without any loss of generality to, and without imposing limitations upon, the claimed subject matter.

Various implementations of the disclosed systems and apparatuses provide face pieces or mask masks for use with SCBA systems that include structural features for attaching items to or near the sealing portion of the face mask without negatively affecting the quality of the seal formed between the face mask and face of the wearer of the SCBA system. These structural features are embodied in an improved gasket apparatus that includes an inner sealing portion and an outer mounting portion. For context, the design and construction of several existing face pieces used with SCBA systems are discussed below. The disclosed technology may be used with a wide variety of existing face pieces, including those shown in the drawings. Current manufacturers of such face pieces include, for example, Scott, Honeywell, MSA, and Draeger. The face masks manufactured by these and other entities may be manufactured to initially include the disclosed gasket apparatus, or such face masks may be retrofitted with the disclosed gasket apparatus. The disclosed gasket apparatus is compatible with the fire protective headgear disclosed in U.S. Pat. No. 10,603,526, which is incorporated by reference herein, in its entirety, for all purposes.

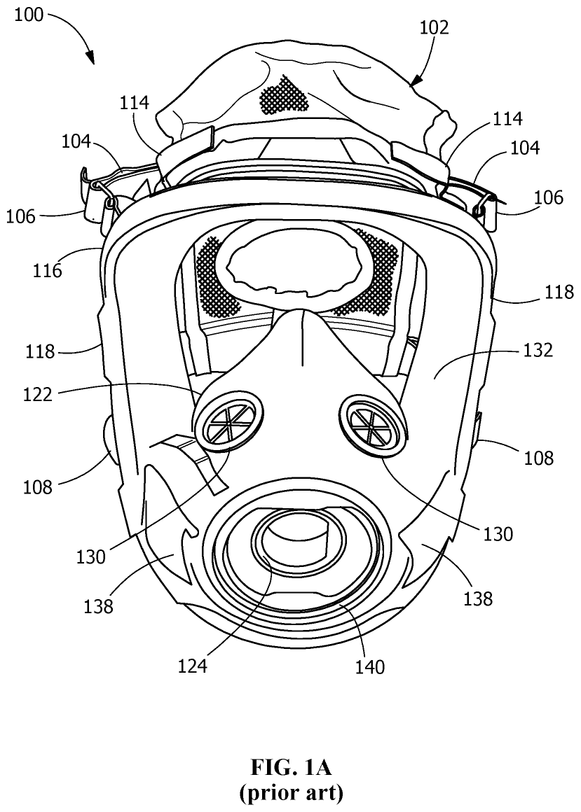

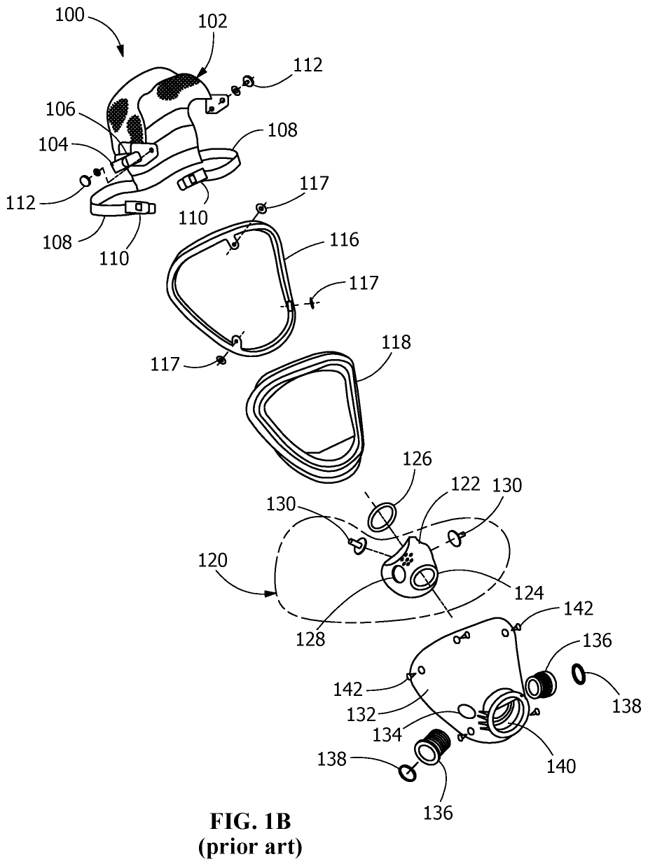

FIGS. 1A-1B depict a first prior art face piece (e.g., Scott V-2000) compatible with the disclosed apparatus, wherein FIG. 1A is a front view of the assembled face piece and FIG. 1B is an exploded view of the face piece. With reference to FIGS. 1A-1B, face piece 100 includes head harness assembly 102 that further includes two temple straps 104, two temple strap buckles 106, two neck straps 108, two neck strap buckles 110, two connector assemblies 112, and two Velcro straps 114. Lens frame 116 surrounds face sealing gasket 118 when face piece 100 is assembled. Nose cup assembly 120 is disposed within face sealing gasket 118 and includes nose cup 122, gas inlet 124, sealing O-ring 126, two inhalation valve apertures 128, and two inhalation valves 130. Face piece lens 132 mounts against and within face sealing gasket 118 and is secured in place by lens frame 116 using connectors 117 and 142. Face piece lens 132 includes two voicemitter apertures 134, two voicemitter ducts 136 mounted within apertures 134, two voicemitters 138 mounted within ducts 136, and gas inlet 140.

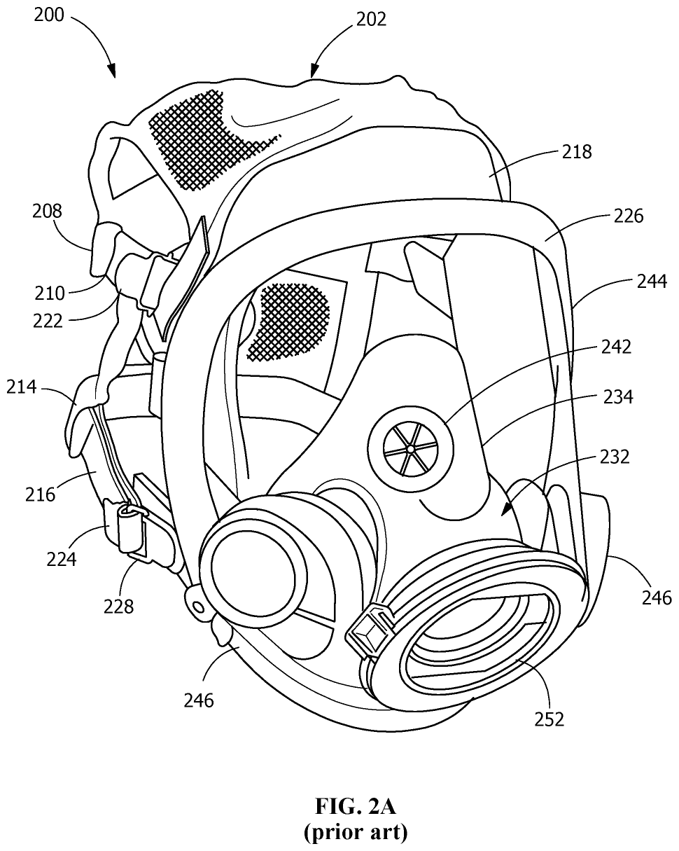

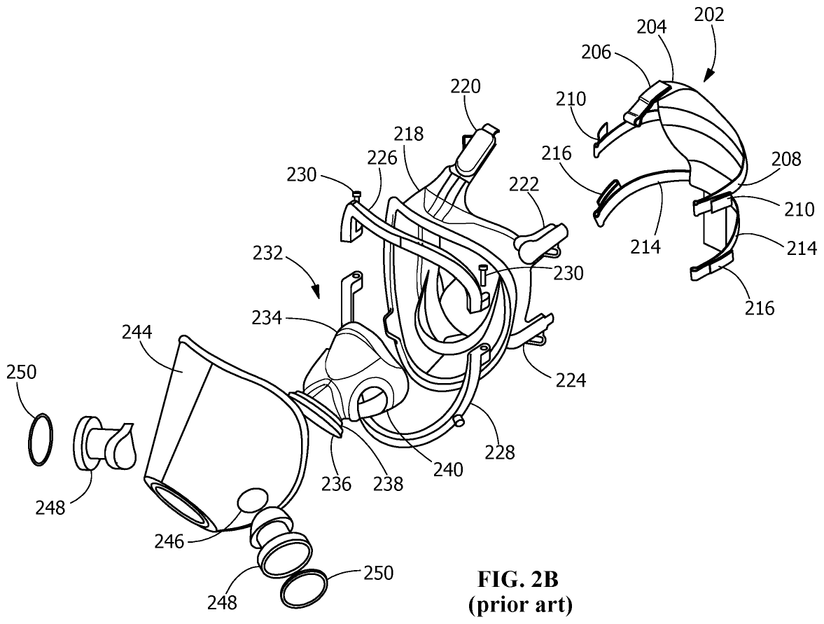

FIGS. 2A-2B depict a second prior art face piece (e.g., Scott V-3000) compatible with the disclosed apparatus, wherein FIG. 2A is a front perspective view of the assembled face piece and FIG. 2B is an exploded view of the face piece. With reference to FIGS. 2A-2B, strap connector 206, temple straps 208, temple strap connectors 210, neck straps 214, and neck strap connectors 216. Face sealing gasket 218 includes forehead buckle 220, which engages forehead strap connector 206, two temple buckles 222, which engage temple strap connectors 210, and two neck buckles 224, which engage neck strap connectors 216. Upper lens frame 226 and lower lens frame 228, which surround face sealing gasket 218 when face piece 200 is assembled are connected to one another using frame screws 230. Nose cup assembly 232 is disposed within face sealing gasket 218 and includes nose cup 234, gas inlet 236, O-ring 238, two inhalation valve apertures 240, and two inhalation valves 242. Face piece lens 244 mounts against and within face sealing gasket 218 and is secured in place by upper lens frame 226 and lower lens frame 228. Face piece lens 244 includes two voicemitter apertures 246, two voicemitter ducts 248 mounted within apertures 246, and two voicemitters 250 mounted within ducts 248, and gas inlet 252.

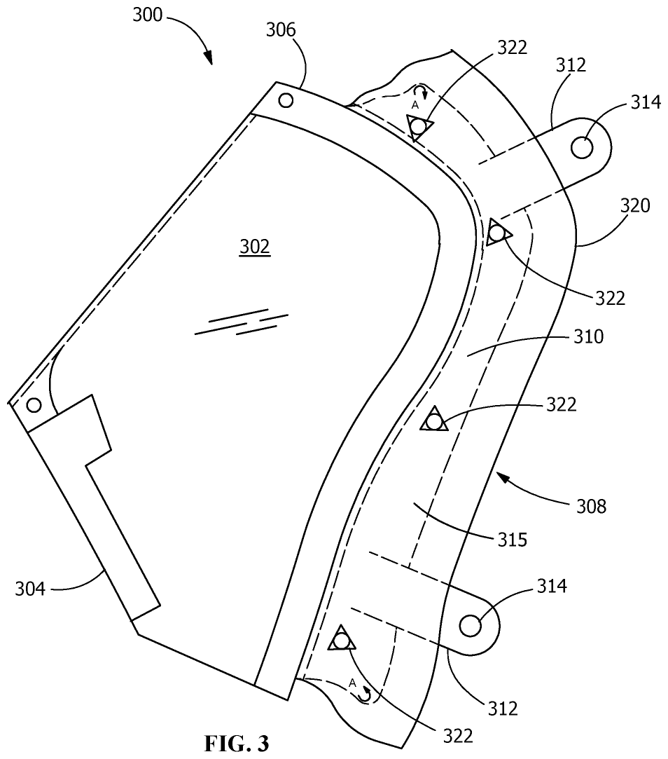

FIG. 3 is a side view of an example implementation of the disclosed face piece for use with a self-contained breathing apparatus showing the relative positions of an inner gasket portion and an outer gasket portion of a dual or multi-gasket assembly. In FIG. 3, head piece 300 includes clear visor 302, regulator connector 304, and rigid rim 306, which supports visor 302. Attached to rim 306 is dual gasket apparatus 308, which includes both inner gasket portion 310 and outer gasket portion 320. Outer gasket portion 320 surrounds inner gasket portion 310 and is typically formed integrally therewith (i.e., as a single or unitary gasket apparatus) for providing additional surface area to the existing mask flange. Inner gasket portion 310 and outer gasket portion 320 define an interstitial space or gap 315 therebetween, which in FIG. 3 may be visualized as the space between the solid outer line and the second, inner broken line nearest visor 302. The disclosed dual-gasket apparatus may be manufactured from flexible rubber, elastomer, or any other suitably pliable material using injection molding or any other suitable manufacturing process.

Inner gasket portion 310 may include inner gasket tabs 312 formed on or attached to its outer surface, each of which may include an aperture 314. Inner gasket 310 surrounds and forms a seal with the face of the user, which acts as a substrate for inner gasket 310. As shown in FIG. 3, in some implementations, inner gasket portion 310 folds over on itself (see small arrows labeled “A” and broken line closest to rim 306) to create a more effective barrier between the outer environment and the skin of the user of face piece 300. Inner gasket tabs 312 and apertures 314 may be used to attach a head harness assembly (similar to item 202 shown in FIG. 2B) to the outer surface of inner gasket 310. Using inner gasket tabs 312 in this manner allows tension created by securing the head harness to inner gasket 310 to pull the inner surface of inner gasket 310 against the face of a user, thereby forming a more effective seal therewith.

A plurality of connectors 322 are included on outer gasket portion 320 for connecting one or more items to outer gasket portion 320 without disrupting the airtight seal formed by inner gasket portion 310 against the face of the user. Suitable connectors may include buckles, buttons, rivets, snaps, hook and loop strips, and other types of connectors. In FIG. 3, snap connector are shown mounted on the outer surface of outer gasket portion 320, with the snap component passing through the material of outer gasket portion 320 and facing inward toward interstitial space 315. A fire-resistant hood, bio-hazard type hood, or other apparel which has corresponding connector components (e.g., the receiving portion of a snap) may be attached to connectors 322 such that the forward edge of the hood rests securely within interstitial space 315, thereby forming a highly effective closure and barrier between the user and the outer environment. This closure acts in the manner of a zipper and forces air to travel inward in a zig-zag manner, thereby making air penetration into the interior of the face piece very difficult. Once the hood is attached to face piece 300 in this manner, duct tape or other sealing tape may be applied over the outer edge of outer gasket 320 and the exposed front portion of the hood to create an additional barrier between the interior of face piece 300 and the outer potentially hazardous environment. In some implementations, the hood may include a “bite” geometry that allows it to attach to both the inner surface of outer gasket 320 and the outer surface of outer gasket 320.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differs from or contradicts this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about” used throughout this specification are used to describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed inventive subject matter. Various functions and elements described herein may be partitioned differently from those shown without departing from the scope of the disclosed inventive subject matter. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the figures, only for facilitating description of the present invention and simplifying the description, rather than indicating or implying that the referred devices or elements must be in a particular orientation or constructed or operated in the particular orientation, and therefore they should not be construed as limiting the present invention. The terms “connected”, “mounted”, “fixed”, etc. should be understood in a broad sense. For example, “connected” may be a fixed connection, a detachable connection, or an integral connection; a direct connection, or an indirect connection through an intermediate medium. For an ordinary skilled in the art, the specific meaning of the above terms in the present invention may be understood according to specific circumstances.

It should be appreciated that all combinations of the foregoing concepts and additional concepts discussed in greater detail herein (provided such concepts are not mutually inconsistent) are contemplated as being part of the disclosed inventive subject matter. In particular, all combinations of claimed subject matter appearing at the end of this disclosure are contemplated as being part of the inventive subject matter disclosed herein. While the disclosed inventive subject matter has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed inventive subject matter in its broader aspects is not limited to any of the specific details, representative devices and methods, and/or illustrative examples shown and described. Accordingly, departures may be made from such details without departing from the spirit or scope of the general inventive concept.

What is claimed:

1. A gasket apparatus, comprising:
(a) an inner gasket portion, wherein the inner gasket portion is adapted to form an airtight seal with a substrate, and wherein the substrate is a human face;
(b) an outer gasket portion formed partially or completely around the inner gasket portion, wherein the outer gasket portion is adapted to receive at least one type of connecting device thereon for connecting one or more items to the outer gasket portion without disrupting the airtight seal formed by the inner gasket portion; and
(c) an interstitial space formed between the inner gasket portion and the outer gasket portion.

2. The gasket apparatus of claim 1, wherein the gasket apparatus is adapted for use with a self-contained breathing apparatus.

3. The gasket apparatus of claim 2, wherein the self-contained breathing apparatus is adapted for use in industrial environments, commercial environments, household environments, firefighting environments, biohazard environments, medical environments, or military environments.

4. The gasket apparatus of claim 1, wherein the outer gasket portion and inner gasket portion are formed integrally with one another from a single piece of material.

5. The gasket apparatus of claim 1, wherein the inner gasket portion includes at least one type of connector device formed thereon or attached thereto.

6. The gasket apparatus of claim 5, wherein the at least one type of connector apparatus on the inner gasket portion is adapted to receive a head harness.

7. The gasket apparatus of claim 1, wherein the at least one type of connecting device on the outer gasket portion includes snaps, buttons, buckles, rivets, or hooks and loop connectors.

8. The gasket apparatus of claim 1, wherein the at least one type of connecting device on the outer gasket portion is adapted to receive a protective item, and wherein the protective item includes a hood, a helmet, a head covering, or the like.

9. The gasket apparatus of claim 1, wherein the interstitial space formed between the inner gasket portion and the outer gasket portion is adapted to receive a portion of a protective hood therein.

10. A dual gasket apparatus, comprising:
(a) an inner gasket portion, wherein the inner gasket portion is adapted to form an airtight seal with a substrate such as a head or face, and wherein the inner gasket portion includes at least one type of connector device formed thereon or attached thereto;
(b) an outer gasket portion formed partially or completely around the inner gasket portion, wherein the outer gasket portion is adapted to receive at least one type of connecting device thereon for connecting one or more items to the outer gasket portion without disrupting the airtight seal formed by the inner gasket portion; and
(c) an interstitial space formed between the inner gasket portion and the outer gasket portion,
(d) wherein the outer gasket portion and inner gasket portion are formed integrally with one another from a single piece of material.

11. The dual gasket apparatus of claim 10, wherein the gasket apparatus is adapted for use with a self-contained breathing apparatus.

12. The dual gasket apparatus of claim 11, wherein the self-contained breathing apparatus is adapted for use in industrial environments, commercial environments, household environments, firefighting environments, biohazard environments, medical environments, or military environments.

13. The dual gasket apparatus of claim 10, wherein the at least one type of connector apparatus on the inner gasket portion is adapted to receive a head harness.

14. The dual gasket apparatus of claim 13, wherein the at least one type of connector apparatus on the inner gasket portion is a gasket tab.

15. The dual gasket apparatus of claim 10, wherein the at least one type of connecting device on the outer gasket portion includes snaps, buttons, buckles, rivets, or hooks and loop connectors.

16. The dual gasket apparatus of claim 10, wherein the at least one type of connecting device on the outer gasket portion is adapted to receive a protective item, and wherein the protective item includes a hood, a helmet, a head covering, or the like.

17. The dual gasket apparatus of claim 10, wherein the interstitial space formed between the inner gasket portion and the outer gasket portion is adapted to receive a portion of a protective hood therein.

18. A gasket apparatus for use with a self-contained breathing system or apparatus, comprising:
(a) an inner gasket portion, wherein the inner gasket portion is adapted to form an airtight seal with a substrate such as a human face, and wherein the inner gasket portion includes at least one type of connector device formed thereon or attached thereto;
(b) an outer gasket portion formed partially or completely around the inner gasket portion, wherein the outer gasket portion is adapted to receive at least one type of connecting device thereon for connecting one or more items to the outer gasket portion without disrupting the airtight seal formed by the inner gasket portion; and
(c) an interstitial space formed between the inner gasket portion and the outer gasket portion,
(d) wherein the outer gasket portion and inner gasket portion are formed integrally with one another from a single piece of material, and
(e) wherein the inner and outer gasket portions are adapted to mount to a visor used with a self-contained breathing apparatus

19. The gasket apparatus of claim 18, wherein the at least one type of connector apparatus on the inner gasket portion is a gasket tab for receiving a head harness, and wherein the at least one type of connecting device on the outer gasket portion includes snaps, buttons, buckles, rivets, or hooks and loop connectors.

20. The gasket apparatus of claim 18, wherein the at least one type of connecting device on the outer gasket portion is adapted to receive a protective hood, and wherein the interstitial space formed between the inner gasket portion and the outer gasket portion is adapted to receive a front portion of the hood therein.
